(19) United States
(12) Patent Application Publication
(10) Pub. No.: US 2007/0237862 A1
(43) Pub. Date: Oct. 11, 2007

(54) Removable Isolation Barrier Packaging

(76) Inventor: Bruce Pinkston, Humble, TX (US)

Correspondence Address: STREETS & STEELE, 13831 NORTHWEST FREEWAY, SUITE 355, HOUSTON, TX, 77040, US

(21) Appl. No.: 11/279,056

(22) Filed: Apr. 7, 2006

(51) Int. Cl. A23B 7/148

(52) U.S. Cl. 426/106

(57) ABSTRACT

The present invention provides a system for packaging and storing components for making a sandwich. The bread and the foodstuffs used for making a sandwich are introduced into and stored in pockets comprising a sandwich bag enclosure and removable barriers disposed therein to form compartments within the enclosure. The removable barriers comprise thin plastic film or sheets material sealably integrated with the sandwich bag enclosure. The present invention provides removable barriers for preventing the wetting of bread due to contact with moist or wet foodstuffs, sandwich components stored in a layered relationship one relative to the others, and easily removed barriers for convenient field preparation of fresh sandwiches.

### BACKGROUND OF THE INVENTION

1. Field of the Invention

The present invention is directed to an apparatus for packaging food that keeps it fresh or separated until the time for consumption. The present invention is directed to a packaging system comprising one or more removable barriers for keeping a material, such as foodstuffs, fresh or isolated from other materials, such as bread, while in storage. The present invention is directed to a container having one or more simultaneously or sequentially removable barriers for keeping objects separated one from the other(s) until such time that contact between the objects is desired, and for facilitating or enabling the isolated storage of articles separated one from the other until the barriers are removed. The present invention is adaptable for storing materials, including foodstuffs, in strata and for isolating materials one from the other(s) until such time that contact between the strata is desired for use or consumption. For example, but not by way of limitation, the present invention may be applicable to batteries, explosives, incendiary devices, exothermic and/or endothermic chemical packs, photography, dye, stencils, fuel cells, and adhesives.

2. Description of the Related Art

Plastic sandwich bags have long been used for providing temporary sealed storage for perishable food items. Resealable plastic bags, such as Zip-Lock® bags, are an example of a storage container. Tupperware® is an example of a storage container that is intended for multiple uses. Initially designed and marketed as a food or sandwich bag, these containers have since gained widespread popularity for much broader, food storage container applications. However, these products generally do not segregate materials or foods that are incompatible. While some plastic food containers do have interior walls or chambers for segregating foods, these generally require removal of lids, removal of the foods from the containers and assembly of sandwiches outside the containers. Such removal and assembly can be difficult in the field or in inclement weather, and the resulting empty container is generally not designed to be disposable.

What is needed is an apparatus for storing sandwich components or other materials that comprises one or more removable barriers for preventing contact between incompatible materials or foods during storage. What is needed is a method of storing and preparing a sandwich that provides for isolation of generally flattened or stratified components one from the other(s) that provides for easy and convenient removal of the isolating barriers, and for convenient combination of the sandwich components to provide a freshly prepared sandwich without the need for manually removing foods from separate enclosures and combining them in the field.

### SUMMARY OF THE INVENTION

In today's fast-moving world, people do not often find time for a meal at a table. Busy parents often feed their children in the back seat of a car on the way to school, baseball practice, gymnastics or dance classes. Often, these meals are purchased at fast-food restaurants at considerable expense and with generally poor nutritional and aesthetic value, or from vending machines.

Eating “on the move” is not always a mere convenience. Modern military units are more mobile, and the need for portable, packaged foods lead to the development of Meals Ready to Eat, or “MREs,” or Mobility Enhancing Ration Components, or “MERCs,” to meet the nutritional needs of mobile military personnel. In 1995, U.S. soldiers were first issued shelf-stable pocket sandwiches in order to provide easy meals for soldiers in the field and in active operations. Within a short amount of time, these meals were being produced by NATO countries and by Israel due to their popularity among the U.S. soldiers.

A shortcoming of the existing MREs, MERCs and shelf-stable pocket sandwiches is that the food does not remain in a fresh and tasty condition, especially where certain components, condiments or moist or wet foods may cause bread or other absorbent foods to become soggy when these foods are disposed in direct contact while in storage or transit. Many types of foods are delicious when eaten together, but are incompatible when kept in direct contact for hours or days before consumption. For example, but not by way of limitation, mustard, mayonnaise, pickles, relish, jelly or tomatoes will soak into dry bread, muffins, bagels and the like when left in direct contact for a prolonged period of time. The breads may become soggy as a result of prolonged contact with the moisture containing foods, and the resulting sandwich is substantially less tasty and less satisfying when consumed.

A sandwich is an example of a structure that is comprised of two or more strata of dissimilar materials that are brought into contact one with the other(s) for use or consumption. Many other devices, apparatuses and systems exist where materials are formed or shaped into layers or strata that are isolated one from others until such time as the materials must be brought together to perform some function, reaction or combination. It is often advantageous to store these strata adjacent and in a prescribed arrangement or sequence one to the others, possibly with a specific ratio when combined.

Removable barriers are used in storing chemicals and chemically treated materials used in fast-developing film for “instant” cameras, such as those manufactured and sold in the 1970s and 1980s by Polaroid®. Barriers that are subject to rupture have also been used in light sticks, cold packs and heat packs where chemicals may be combined upon demand to give off light or to produce or absorb heat through exothermic or endothermic chemical reaction.

For example, but not by way of limitation, some electro-chemical batteries may contain components or cells that have a generally flattened configuration and that are best preserved for optimal performance on demand if these components or cells are isolated one from the others until electricity is needed. Selected battery components which can form cells having a generally stratified shape or generally flattened faces disposed therebetween may be isolated one from the other(s) using the removable barrier(s) of the present invention. The removable barrier(s) of the present invention may be installed between the battery components or cells upon assembly and later, when removed, to provide electrochemical contact between the adjacent faces or surfaces of battery components or cells to initiate electrochemical power generation.

A chemical pack, either endothermic for providing cold compresses, or exothermic for providing heat, may comprise chemicals, sometimes in the form of liquids or gels, or chemically treated materials having a generally flattened or stratified components that are designed to remain isolated one from the other(s) until such time as the chemicals or chemically treated components are brought into contact and the desired heat generating or absorbing reaction is enabled in order to generate heat or cold, respectively. The removable barrier(s) of the present invention may be disposed between adjacent strata of chemicals, or chemically treated components, and later removed to provide contact between the chemicals or chemically treated components to enable chemical reaction(s).

The removable barrier(s) of the present invention may be applied to isolate an ink or a dye or a material treated with ink or dye and having a generally flattened or stratified configuration from air, fabric and/or other materials that might react with and activate the dye. The removable barrier(s) may be removed to provide contact between the dye or the dye treated material and a substrate to be marked, tagged or labeled using dye. This application of the removable barrier(s) of the present invention may also include the use of templates, stencils or guides disposed between the dye or the dye treated material and the substrate to be marked, tagged or labeled so that a mark, number, icon, indicator, symbol, bar code or other message may be either temporarily or permanently imposed upon the targeted fabric, substrate. This application is particularly suited to the marking of the skin or clothing of persons, such as prisoners or detainees, animals, automobiles or military equipment, trees, automotive tires, tents or other fabric covers, etc. These removable barriers are advantageous for use in the field where it is impracticable to use conventional stencils, paint, tattoos or sewn labels.

The present invention provides for easy and convenient storing of the components of a sandwich using one or more removable barriers to prevent contact between the components during storage, and for easy and convenient assembly of a sandwich from the isolated components by removal of the removable barriers to dispose the components into contact one with the others. One embodiment of the present invention provides a pair of removable barriers that are integrated with a containment enclosure or a sandwich bag for storing the sandwich components in position, one relative to the other(s), to instantly produce a fresh sandwich upon removal of the barrier(s). In one embodiment, the removable barrier(s) is (are) removed from their isolating positions between components using one or more tethers or pull sheets to slidably remove the removable barrier(s). The removable barrier(s) and or the tethers or pull sheets may be sealably integrated with a sandwich bag that combines with the removable barriers to create pockets for storing generally flattened or stratified sandwich components that may be later combined together to make a fresh sandwich. The removable barrier(s) serve to isolate sandwich components one from the others, and to thereafter facilitate the joining of stratified layers of foods into a sandwich that is ready for consumption upon removal of the barrier(s).

The removable barrier of the present invention may also be applied for storing and selectively isolating materials other than foods. The removable barrier disclosed herein may be used in connection with batteries where it is desirable to store the electrodes or electrochemical components thereof in a condition isolated one from others or from an electrolyte until such time as the user wishes to activate the battery for use. The removable barriers of the present invention may be used to conveniently and efficiently dispose previously isolated components into working and functioning contact one with others without time-consuming unpackaging of separately isolated components, removal of components from wrappers or packaging, or reassembly of components into assembled devices or structures. The removable barrier of the present invention may also be applied for preventing contamination of materials stored using the barriers. The application of the present invention to foods will be discussed in detail, but those skilled in the art of batteries, adhesives, explosives, chemical packs, dyes, fuel cells and the like will appreciate the adaptability of the present invention to other fields and applications.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are, therefore, not to be considered limiting of its scope, for the invention may admit to other equally effective embodiments. The drawings are designed to illustrate the configuration of thin structures and their positions and interaction, and the relative thickness, length or proximity may be exaggerated to some extent for purposes of better communicating structure, function, movement or interaction.

FIG. 1 is a perspective view of one embodiment of the removable barrier of the present invention in the isolating position and having two generally planar removable barriers adjacent one to the other.

FIG. 2 is a side elevation view of one embodiment of the removable barrier of the present invention in the isolating position and having two generally planar removable barriers adjacent one to the other.

FIG. 3 is a front elevation view of one embodiment of the removable barrier of the present invention in the isolating position and having two generally planar removable barriers adjacent one to the other.

FIG. 4 is a side elevation view of one embodiment of the present invention in the isolating position and having two generally planar removable barriers generally parallel one relative to the other and positioned to isolate each of the two strata of material (in this case, two slices of bread) from an intermediate stratum of material positioned between the two generally planar removable barriers.

FIG. 5 is a side elevation view of the embodiment shown in FIG. 4 of the removable barriers of the present invention partially slidably removed from their isolating positions toward their removed positions.

FIG. 6 is an enlarged view of the traveling fold portion of one embodiment of a removable barrier of the present invention as it is slidably removed from its isolating position toward its removed position.

FIG. 7 is a side elevation view of one embodiment of the removable barriers of the present invention in the isolating position and having two generally planar removable barriers generally parallel one to the other and positioned on either side of an intermediate stratum of material to isolate the slices of bread from the stratum of material positioned between the removable barriers. The removable barriers and the stratum of material and bread slices separated thereby may all be received within and sealably contained within a sandwich bag that is integral with the removable barriers.

FIG. 8 is an enlarged cross-sectional view of a portion of the embodiment of the removable barriers described and shown in FIG. 7, but with the bottom and/or edge portions of the sandwich bag ruptured along frangible zones in order to allow the removable barriers to be slidably removed from their isolating positions by application of a pulling force on the tether or pull tab that is coupled to the removable barriers.

FIG. 9 is a side elevation view of the same embodiment of the present invention shown in FIG. 7. FIG. 9 shows an intermediate configuration of the removable barriers while being removed from their isolating positions with the pull tab displaced downwardly away from the opened bottom of the sandwich bag by application of a pulling force.

FIG. 10 is a perspective view of an embodiment of the present invention with two removable barriers with each removable barrier comprising a single loop of thin sheet film adapted to receive a generally flat frame therein for imparting a generally planar and flattened configuration to the loop.

FIG. 11 is a side view of the embodiment of the present invention shown in FIG. 10.

FIG. 12 is a perspective view of an embodiment of the present invention having a pair of removable barriers received within a sealable enclosure with two compartments for receiving a dye in one compartment and one or more stencils in the other compartment.

FIG. 13 is a cross-section side view of the embodiment of the present invention shown in FIG. 12.

FIG. 14 is a perspective view of an embodiment of the present invention having a pair of generally adjacent compartments, each having at least one removable barrier for selectively disposing the compartment in communication with a material that may be in the adjacent compartment or it may be outside the compartments.

FIG. 15 is a cross-section side view of the embodiment of the present invention shown in FIG. 14.

### DETAILED DESCRIPTION

Embodiments of the present invention are shown in the attached drawings. It should be understood that the removable barriers and related apparatuses have a variety of configurations that all serve the purpose of the invention. The purpose served by the removable barriers and related apparatuses is to provide one or more substantially impermeable isolating barriers that prevent reactants, agents, solvents, vapors, flavor, smell, chemicals, ions, cations or anions, moisture or water content from one food or material from soaking into, spoiling, reacting with or otherwise fouling another food or material that may be stored or positioned on the opposite side of a removable barrier before communication is desired. The removable barrier(s) of the present invention must be physically disposed in a manner that provides for easy removal from the isolating position without damaging, dragging, disturbing or otherwise substantially diminishing the condition or amount of foods or material to which the removable barrier might adhere.

The application of the present invention to foods in the embodiments disclosed herein is for purposes of illustrating and explaining the structure, function, removal and interaction of the removable barriers and related apparatuses. The removable barriers are also adapted for use with adhesives, batteries, incendiary devices, explosives, exothermic and endothermic chemical packs and the like where chemicals or chemically treated materials may be stored and later activated or combined, all while remaining in common enclosures or packaging.

FIG. 1 is a perspective view of one embodiment of the present invention with twin removable barriers 31a, 31b. Each barrier is shown in the isolating configuration, folded to form a generally rectangular barrier with double thickness. The two removable barriers 31a, 31b are generally formed adjacent one to the other, and adapted for being spaced apart to accommodate an isolatable strata therebetween. The two barriers shown in FIG. 1 are the first barrier 31a and the second barrier 31b, and each is comprised of a single elongated and thin sheet 30 of plastic or some similar material. The sheet shown in FIG. 1 has a first end 20a and a second end 20b, the first and second ends 20a, 20b being joined together to form a pull tab 20 for removing the removable barriers 31a, 31b from their isolating positions. The portion of the sheet 30 between the first and second ends 20a, 20b having a first set of folds 30a and 33a and second set of folds 30b and 33b to form a pair of parallel, generally planar folded portions. The first folded portion comprises a pulled portion 32a and peeled portion 34a, and the second folded portion comprises a pulled portion 32b and peeled portion 34b. Each area of each folded portion is determined by the locations in the elongated sheet 30 of the folds 30a, 30b, 33a and 33b. The preferred embodiment has the folded portions of equal size with substantially equal spacing between the folds that form the folded portions.

The folded portions of the elongated sheet 30, when positioned on each side of a foodstuff having a generally flattened shape, isolate the foodstuff from other materials, such as bread slices, that may then be stored on the outer sides and/or between of the folded portions of the removable barrier portion 10. For example, but not by way of limitation, several slices of ham, which is a foodstuff, may be positioned between the removable barriers. The ham would be brought in contact with the interior surfaces of each peeled portion 34a, 34b of the removable barriers. Slices of bread could then be brought into contact with the exterior surfaces of the pulled portions 32a, 32b of the removable barriers to form a sandwich. The impermeable removable barriers prevent moisture from the ham from being absorbed by the dry bread, thereby keeping the ham fresh and the bread dry and not soggy.

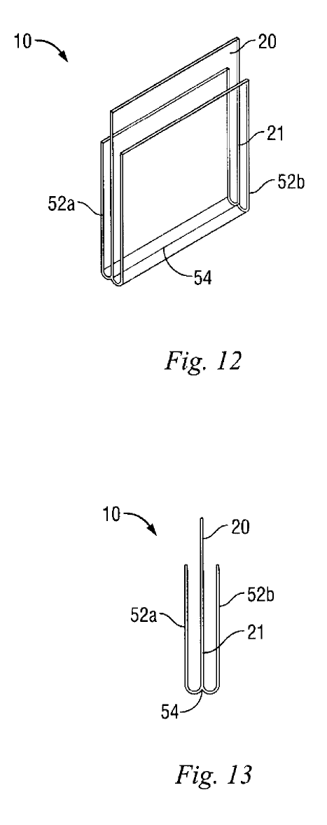

The material thickness and spacings in FIG. 1 are exaggerated to better show the configuration of the removable barrier 10. There generally will not be any visible spacing between the interior side of the pulled portion 32a and the exterior side of the peeled portion 34a, and there generally will not be a visible spacing between the interior side of the pulled portion 32b and the exterior side of the peeled portion 34b. There will generally be a visible spacing between the interior side of the peeled portion 34a and the interior side of the peeled portion 34b to accommodate the foodstuff that is isolated from the bread slices placed against the exterior sides of the pulled portion 32a and the pulled portion 32b. The foodstuff may be of a type that will adhere to the interior side of the peeled portion 34a and to the opposing interior side of the peeled portion 34b, much like the slice of cheese adheres to the smooth sheet of plastic film used for wrapping individual cheese slices. This adhesion is the reason that the peeling action is best suited for removal of the removable barrier from its isolating position between the foodstuff and the bread. The dry bread does not generally adhere to thin plastic film or sheet, and the pulled portion of the sheet is disposed toward the bread to provide low friction sliding and wiping contact along the face of the bread while providing peeling action to remove the removable barrier from its contact with the moist or wet foodstuff. If two materials, each disposed to adhering to a film barrier are separated one from the other, then the embodiment of the removable barrier described later in connection with FIGS. 12 and 13 are better suited for this application.

The material selected for the sheet should be a thin film sheet of plastic or other material having a low coefficient of friction and adequate strength so that the pulled portions slide easily against the peeled portion when the removable barriers are removed, as described below.

Folds 30a, and 30b may comprise a single fold, two folds, or they may comprise a generally “U”-shaped portion of the sheet 30 formed to couple peeled portion 34a to peeled portion 34b. In an alternative embodiment, the removable barrier may have two elongated sheets, each having the end joined back to sheet to form a loop at the end of each elongated sheet, each of which may be coupled to a tether, as shown in FIGS. 10 and 11.

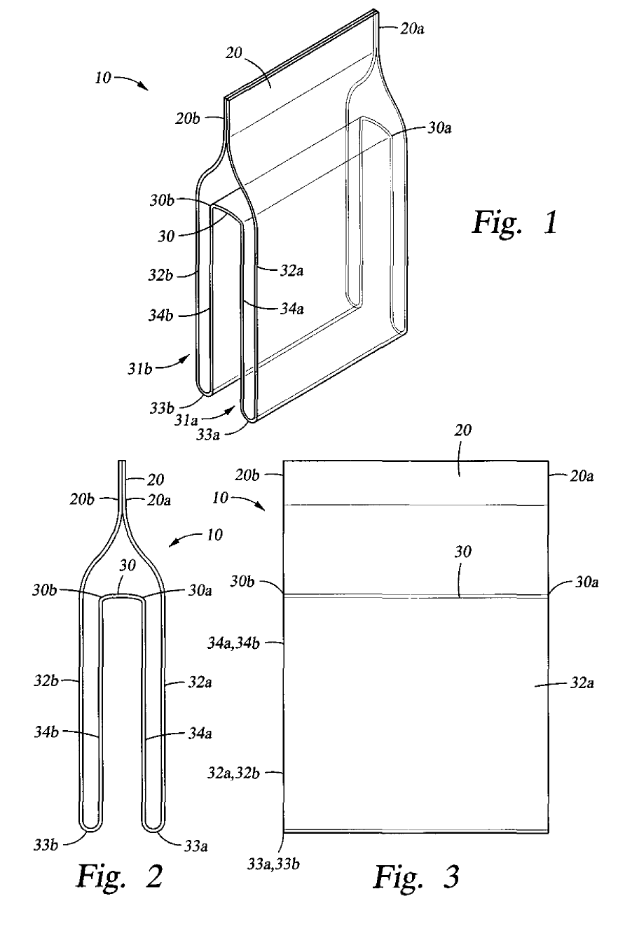

FIG. 2 is a side elevational view of one embodiment of the removable barrier portion of the packaging system of the present invention in the isolating position with two removable barriers adjacent one to the other. Again, the spacing between the proximal peeled portion 34a and the distal peeled portion 34b is exaggerated in order to illustrate the structure of the removable barrier portion of the packaging system. In the embodiment shown in FIG. 2, the pull tab 20 is comprised of the first end 20a and the second end 20b, and the pull tab 20 is coupled to the proximal pulled portion 32a and the distal pulled portion 32b. FIG. 2 shows how the sheet that makes up the two removable barriers and the pull tab 20 may be of uniform thickness.

FIG. 3 is a front elevational view of one embodiment of the removable barrier portion 10 of the packaging system of the present invention in the isolating position with two removable barriers adjacent one to the other. FIG. 3 shows how the sheet that makes up the two removable barriers and the pull tab 20 is preferably of uniform width.

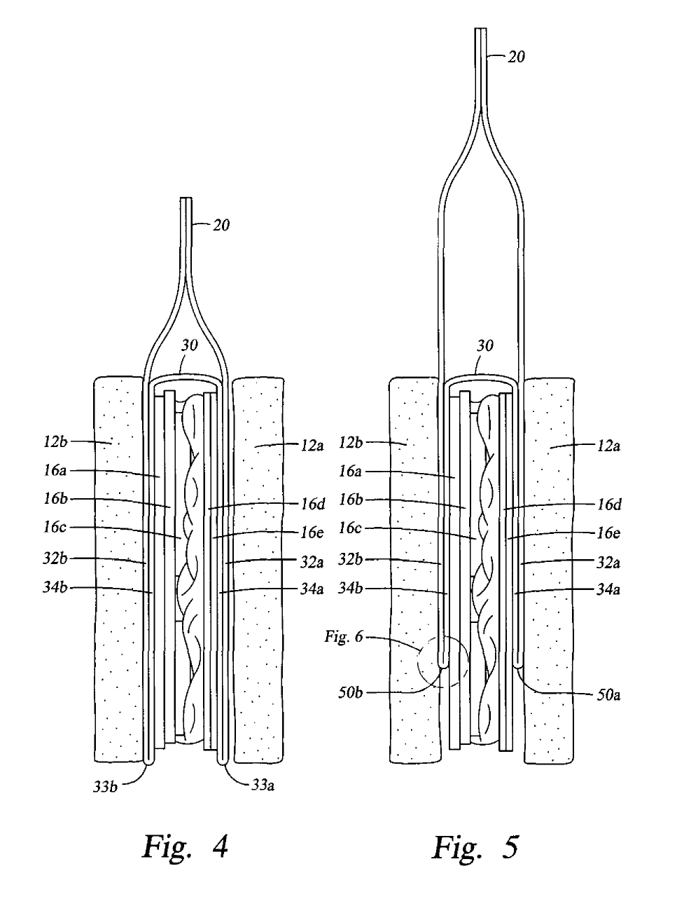

FIGS. 4 and 5 show how one embodiment of the removable barrier portion of the present invention may be used to store and isolate materials. FIG. 4 is a side elevation view of one embodiment of the packaging system of the present invention in the isolating position with two removable barriers generally parallel and planar one to the other and positioned to isolate slices of bread from the foodstuff mass disposed between the removable barriers. The foodstuff mass, in this case ham 16c and slices of cheese 16a, 16b, 16d and 16e, are placed together to form a generally flattened foodstuff mass having approximately the cross-sectional area or shape of a slice of bread. This foodstuff mass is placed in the interior spacing formed between the removable barriers of the removable barrier portion of the present invention in the manner shown in FIG. 4. The mass is in contact with the interior side of the peeled portion 34a on one side and in contact with the interior side of the peeled portion 34b on the other side. Unlike the exaggerated drawings of FIGS. 1 and 2, FIGS. 4 and 5 show the peeled portion 34a in generally planar contact with pulled portion 32a, and peeled portion 34b in generally planar contact with pulled portion 32b. The removable barriers are removed from their isolating position shown in FIG. 4 by pulling and displacing the pull tab 20 upwardly (as shown in FIG. 4) and away from the sandwich. When the pull tab 20 is grasped and pulled, tension in the pulled portions 32a and 32b causes the removable barriers to be removed. Specifically, the tension in pulled portion 32a causes the sheet 30 to peel away from the slice of cheese 16e starting at fold 33a, and the exterior side of pulled portion 32a to slide along the interior face of the bread slice 12a in the direction of the pulled pull tab 20. At the same time, the tension in pulled portion 32b causes the sheet 30 to peel away from the slice of cheese 16a starting at fold 33b, and the exterior side of pulled portion 32b to slide along the interior face of the bread slice 12b in the direction of the pulled pull tab 20.

FIG. 5 is a side elevation view of one embodiment of the removable barrier portion 10 of the packaging system of the present invention partially removed from its isolating position with two partially removed removable barriers adjacent one to the other, and separating slices of bread from the foodstuff mass between the removable barriers. FIG. 5 shows the progression of the peel points 50a and 50b (that started as 33a and 33b in FIG. 4) as the removable barriers are removed from their isolating positions shown in FIG. 4 to prepare the sandwich for consumption. FIGS. 4 and 5 provide a sliding contact (between thin film sheet portion 34a and 16e and between thin film sheet portion 34b and 16a) and a peeling contact (between thin film sheet portion 32a and piece of bread 12a and also between thin film sheet portion 34a and slice bread 12a) for each removable barrier, then the optimal use of the embodiment of the removable barriers shown in FIGS. 4 and 5 is to place the sliding contact between the thin film sheet and the low coefficient of friction strata (dry bread) and the peeling contact between the thin film sheet and the high coefficient of friction strata (cheese). A lubricant, such as powdered sugar or cornstarch, may be disposed on the sliding surface to promote smooth sliding.

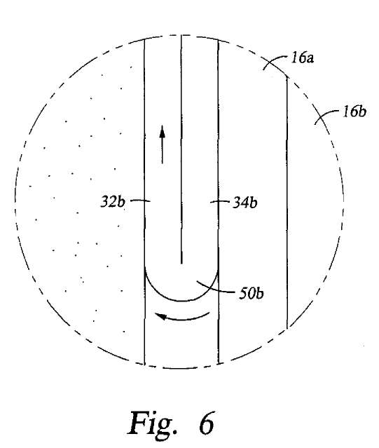

FIG. 6 is an enlarged view of the folded portion of one embodiment of one of the removable barriers having a moving peel point 50b. The arrow shows the direction of travel of the pulled portion 32b as the pull tab 20 is pulled to remove the removable barriers from their isolating position shown in FIG. 4.

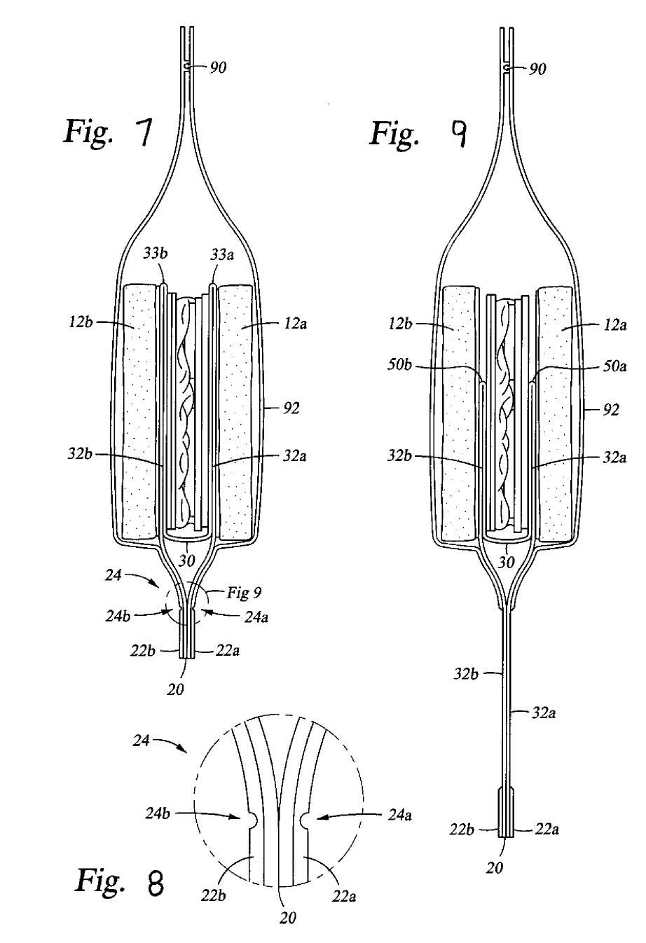

FIG. 7 is a side elevation view of one embodiment of the packaging system of the present invention in the isolating position with two removable barriers generally parallel and planar one to the other and positioned to isolate slices of bread from the material between the removable barriers. The packaging system and the foodstuff mass and bread separated thereby are all received within, and sealably contained within, a sandwich bag 92 sealably coupled to the removable barrier system and having a frangible zone 24 for selectively providing for a predetermined location of rupture when the pull tab 20 is gripped and pulled downward generally along the centerline of the sandwich and in a direction away from the removable barriers. This coupling may be located at or near the pull tab 20. The sandwich bag 92 may sealably couple to the removable barrier pull tab 20 using adhesive or using any of a number of methods known to those skilled in the art for sealably fusing or coupling one plastic film to another including, but not limited to, adhesive and thermo-bonding. The sandwich bag 92 may further comprise a rupture line 24 generally located on the opposite end of the sandwich bag 92 from a closure 90. The rupture line 24 is a line that goes substantially all of the way around the sandwich bag 92 in a direction that is generally parallel to the direction of the closure 90 at the opposite end of the sandwich bag 92 and also generally parallel to the end of the pull tab 20 that is generally adjacent to the rupture line 24. The rupture line 24 is a portion of the sandwich bag 92 material that is predisposed, usually by mechanical modification, to structural failure by rupture when the pull tab 20 is pulled by the user with sufficient force to rupture the material along the rupture line 24. Rupture along the rupture line 24 provides for easy removal of the removable barriers by the user.

FIG. 8 is an enlarged cross-sectional view of the rupture line 24 of the present invention described in connection with FIG. 8 above. The rupture line 24 shown in FIG. 8 comprises a frangible zone that extends substantially all of the way around the outwardly directed periphery of the sandwich bag 92. The frangible zone 24 may comprise a zone of decreased thickness of the material to provide an overall sheet thickness that is less than that of the surrounding material of the sandwich bag 92, or it may comprise a zone of material that has been mechanically altered in some manner, such as a series of perforations, to weaken the material within the predetermined frangible zone and to define the desired zone of failure. When tension is applied to the sandwich bag 92 by pulling the pull tab 20, the rupture line 24 is predisposed to failure along the predetermined line of decreased thickness, thereby allowing the pull tab 20 to move outwardly away from the sandwich bag 92 and to remove the removable barriers from their isolating positions shown in FIG. 7.

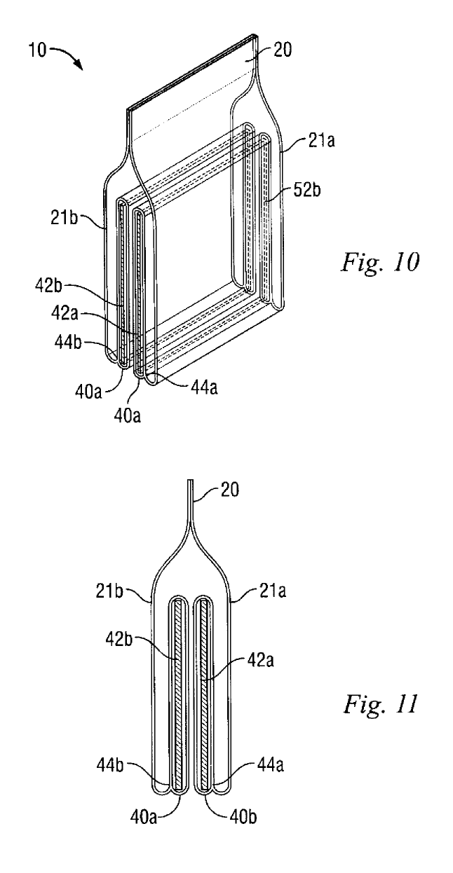

FIG. 9 is a side elevational view of the same embodiment of the packaging system of the present invention shown in FIG. 7. FIG. 9 shows the configuration of the removable barriers with the pull tab 20 displaced a distance away from the sandwich bag 92 by pulling. The displacement of the pull tab 20 has pulled the pulled portions 32a, 32b downwardly and peeled the peel portions 34a, 34b downwardly along the interface between the peel portions 34a, 34b and the foodstuffs mass 16a, 16e, respectively. As can be seen in FIG. 9, further displacement of the pull tab 20 away from the sandwich bag 92 will result in the complete removal of the removable barriers from their isolating position, and this will leave the bread slices 12a, 12b in contact with the foodstuffs 16a, 16b, 16c, 16d and 16e in a condition such that the sandwich is assembled and ready to consume upon removal of the prepared sandwich from the sandwich bag 92.

FIGS. 10 and 11 show another embodiment of the removable barrier of the present invention. FIGS. 10 and 11 show a pair of removable barriers positioned side by side. The removable barriers shown in FIGS. 10 and 11 are comprised of two loops 40a and 40b, each formed of a thin film sheet. The loops 40a and 40b may be formed by coupling the ends of an elongated thin film sheet. This embodiment of the removable barriers 10 further comprises inserts 42a and 42b, which may be any generally structurally rigid frame, such as a card. The inserts 42a and 42b may be approximately the size and shape of a flattened slice of bread and each is received within a loop 42a and 42b, respectively, to support and maintain the loop in its generally planar and flat configuration. Accordingly, each loop 40a and 40b is formed from an elongated film sheet having a length slightly greater than twice the height of a slice of bread such that a loop formed by joining one end to the other end will flatten and receive the insert therein. Just as the spacing between adjacent portions of the thin film sheet are exaggerated in FIGS. 1 and 2 to better show the structure of the removable barrier (but shown to be in sliding contact in FIGS. 4, 5, 6, 7 and 9), the spacing between adjacent portions of the thin film sheet in FIGS. 10 and 11 are also exaggerated to better show the structure of this embodiment of the removable barrier. In actual use, the portions of the loop 40a, on each side of the insert 42a received within the loop 40a, are in sliding contact as the removable barrier is removed from its isolating position between two strata. Similarly, the portions of the loop 40b, on each side of the insert 42b received within the loop 40b, are in sliding contact as that removable barrier is removed from its isolating position between two strata.

The removable barriers shown in FIGS. 10 and 11 are designed to be removed by movement in the upward direction. The removal of the removable barriers is accomplished by pulling tether sheets 21a and 21b. Displacement of the pull tab 20 that is coupled to the tether sheets 21a and 21b cause each of the loops 40a and 40b to progress or rotate about the insert or frame received therein, with relative motion similar to that of a track on a bulldozer, but having a much flatter profile. Each loop 40a and 40b is coupled to one end of a tether sheet 21a and 21b, respectively, and, when the removable barriers are deployed in their isolating positions, the tether sheets couple to the end of the generally flattened loop. The other end of the tether sheets are joined together at a pull tab 20.

The insert received within each loop should be of a material that provides for a generally low coefficient of friction with the thin film sheet material from which the loop is made to provide for smooth sliding contact between the insert and the interior surface of the loop for progressing or rotation of the loop about the insert for removal of the removable barrier. By rotation, it is not suggested that a point on the loop makes a circular path relative to the insert, but instead that a point on the loop will follow an elongated and flattened path generally around and near to the insert, and generally along the path defined by the cross-section of the material from which the loop is made.

The removable barrier pairs in the embodiment of the present invention described above in connection with FIGS. 1-9 may comprise a single elongated sheet folded at a plurality of positions along the continuous sheet to form a pair of generally parallel and identical removable barriers. There are variations of using a single elongated sheet that can form one or more of the removable barriers of the present invention, and such variations may, like those described in connection with FIGS. 7-9, function with the sandwich bag enclosure in a manner similar to that described above in connection with FIGS. 10 and 11, the twin loop design. Similarly, the “T”-shaped configuration disclosed below in the connection with FIGS. 12 and 13 may also function with a sandwich bag enclosure.

FIG. 12 is a perspective view of another embodiment of the removable barrier of the present invention. FIG. 13 is a side view of the embodiment shown in FIG. 12. This embodiment of the removable barrier comprises a thin film sheet material having a “T”-shaped configuration comprising a right wing 52a and a left wing 52b, each coupled to a center pull sheet 21 that is coupled at its bottom to a pull tab 20. The right wing 52a and the left wing 52b are each coupled along a line of intersection to the pull sheet 21. In the embodiment shown in FIGS. 12 and 13, the right wing 52a, left wing 52b and the pull sheet 21 are all joined together along a common line of intersection 54 into a single removable barrier 10. The spacing between the right wing 52a and the pull sheet 21, and the spacing between the left wing 52b and the pull sheet 21, as shown in FIGS. 12 and 13, are exaggerated to show the structure and relationship between the components of this embodiment of the removable barrier. When in its deployed or isolating position, the right wing 52a may be disposed in contact with and adjacent to the pull sheet 21, and the left wing 52b may be disposed in contact with and adjacent to the pull sheet 21. It is important to note that although the embodiment shown in FIGS. 12 and 13 has two wings 52a and 52b, the embodiment shown in FIGS. 12 and 13 is a single removable barrier, not a pair of removable barriers as is shown in FIGS. 1, 2, 4, 5, 7, and 9-11. Where the embodiment of the removable barrier shown in FIGS. 1, 2, 4, 5, 7, and 9-11 has both peeling contact with one stratum and sliding contact with an adjacent stratum during removal, the two wings 52a and 52b provide outwardly opposite surfaces of a single barrier, both having peeling contact removal from the adjacent strata, and the sliding contact is, on one side, between the inwardly disposed surface of the right wing 52a and the adjacent surface of the pull sheet 21 and, on the other side, between the inwardly disposed surface of the left wing 52b and the adjacent surface of the pull sheet 21. This embodiment of the present invention provides two peel surfaces per removable barrier as opposed to one peel surface per removable barrier as is provided by the embodiments of the present invention shown in FIGS. 1, 2, 4, 5, 7, and 9-11.

The preferred method of using the removable barriers of the present invention depend on the configuration, the application and the embodiment. However, the removable barrier of the present invention is adapted to isolate a stratum from an adjacent stratum, and that placement of the strata on either side of the removable barrier of the present invention can be done without damaging distorting or unduly affecting or otherwise impairing the shape of the strata during removal of the removable barrier.

As is shown in FIGS. 12 and 13, the pull tab 20 is coupled to the pull sheet 21, and when the pull tab 20 is grasped and pulled upwardly and away from the strata (not shown) separated by the removable barrier comprised of the three layers, the right wing 52a, the left wing 52b and the pull sheet 21 therebetween, the pull sheet 21 pulls and progressively peels both the right wing 52a and the left wing 52b away from the strata. This mechanical action is similar to that shown in connection with FIGS. 1,2,4,5,7 and 9, except that there is no sliding contact between the strata and the thin film sheet.

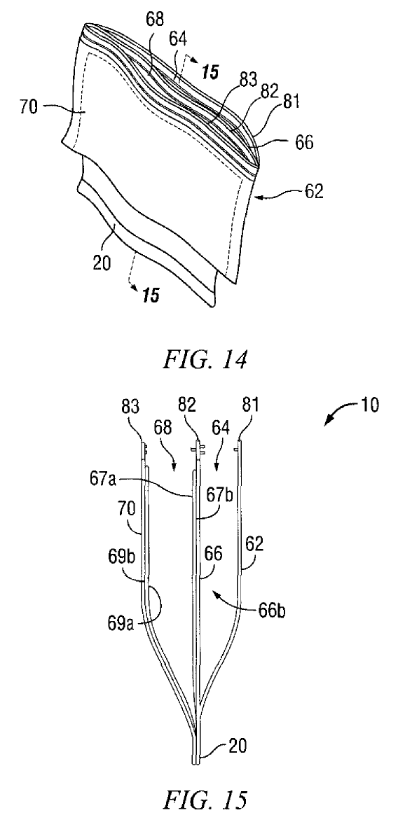

FIGS. 14 and 15 show an embodiment of the removable barriers of the present invention used for removably isolating one chamber or compartment within a resealable enclosure from another adjacent chamber or compartment. This embodiment may be used for applying dye to a surface using a stencil.

FIG. 14 shows one embodiment of a plastic enclosure 110, such as a sandwich bag, having generally parallel exterior walls 62 and 70, but also having in interior intermediate wall 66 sealably separating the enclosure 110 into two separate compartments 64 and 68, the first compartment 64 defined by walls 62 and 66, and the second compartment 68 defined by walls 66 and 70. Each compartment has a resealable closure, such as that used in a Zip-Lok® bag. Compartment 64 closes using the sealing closure comprising edge 81 and 82. Edge 82 is a bi-directional sealing closure, so that compartment 68 closes using the sealing closure comprising edges 82 and 83.

Wall 66 is comprised at least in part by a removable barrier of the present invention. Wall 66 is comprised of a film having a window, 66b which may be an aperture or a plurality of apertures in wall 66 for providing communication between the two compartments 64, 68 separated by the wall 66 and the window 66b the window 66b is in the wall 66, which is interior to the exterior walls 62 and 70. The plurality of apertures may comprise a pattern such that removal of the removable barrier from the wall 66 to establish communication between compartments 64, 68 may provide fluid communication between compartments while containing any ink pads, dye pads or stencils that are disposed in one or more of the compartments.

The wall 66 comprises, in at least some portions, at least two layers, one being a removable barrier. In FIG. 15, the removable barrier comprised of film 67b coupled to tether 67a comprises a layer of wall 66. Film 67b may be releasably secured to the side of the wall 66 in a manner to cover the window 66b, or an aperture or plurality of apertures, therein until such time that the film 67b can be removed by pulling the tether 67a to peel the film 67b from the wall 66 to establish communication between compartments 64, 68. Similarly, an exterior wall of the enclosure of the present invention may be adapted for being opened or for exposing a window, which may be an aperture or plurality of apertures. As shown in FIG. 15, film 69b is releasably secured to the interior side of the exterior wall 70 in a manner to cover a window (not shown), aperture or plurality of apertures in the exterior wall 70 until such time that the film 69b can be removed by pulling the tether 69a to peel the film 69b from the exterior wall 70.

This embodiment of the present invention has many uses. For example, but not by way of limitation, a liquid dye pad or an absorbent material substantially saturated with dye or ink may be inserted and sealed into compartment 64, and a stencil having a message within it, such as a number or bar code, may be disposed in the adjacent compartment 68. The dye and or the stencil may remain sealed within their respective compartments 64 and 68 until such time that the user desires to apply a message to a surface such as a tree, fence, wall, automobile, animal or even to a human. The message is applied by placing the exterior wall 70 having a removable film 69b thereon against the object on which the message is to be applied, and by applying generally uniform pressure to the opposite wall 62, and then by removing the removable film 67b and 69b from wall 66 and exterior wall 70, respectively, to allow the dye or ink to contact the object through the now opened window 66b of the interior wall 66, the stencil (not shown) and the aperture or apertures opened in exterior wall 70.

Materials used for the removable barriers must be lightweight, flexible and suitable for sealably engaging other materials used to make the sandwich bag enclosure. The materials should also have a low coefficient of friction. The preferred materials for the removable barriers described herein are thin film sheets, such as that used to individually wrap cheese slices sold commercially in grocery stores. The preferred materials for the sandwich bag portions that may be sealably integrated with the removable barriers.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A removable barrier apparatus adapted for isolating one stratum of material from another stratum of material comprising:
an elongated film having a first end and a second end joined together to form a film loop having an elongated passage therethrough and an exterior surface;
a generally planar insert slightly less than half the length of the elongated film received within the passage of the film loop for imparting a generally flattened and elongated shape to the film loop; and
a tether coupled to the exterior surface of the film loop for imparting movement to the film loop;
wherein the movement of the film loop relative to the insert received within the passage therein is obtained by pulling the tether in a direction generally parallel to the planar surface of the insert to remove the removable barrier from its position between the strata.

2. The removable barrier apparatus of claim 1 further comprising:
an enclosure having a resealable closure at a first end for receiving strata of material and an elongated slit at the other end for sealably receiving the tether.

3. The removable barrier apparatus of claim 2 further comprising:
the apparatus of claim 2 wherein the enclosure is a sandwich bag.

4. A removable barrier apparatus adapted for isolating one stratum of material from another strata of material comprising:
two or more elongated films, each having a proximal end and a distal end joined together to form a film loop, each film loop having an elongated passage therethrough and an exterior surface;
an generally planar insert slightly less than half the length of each elongated film received within the passage of each film loop for imparting a generally flattened and elongated shape to the film loop; and
a tether coupled to the exterior surface of each film loop for imparting movement to the film loop;
wherein the movement of the film loops relative to the insert received within the passage therein is obtained by pulling the tethers in a direction generally parallel to the planar surfaces of the inserts to remove the removable barriers from their positions between strata of material.

5. A removable barrier apparatus for isolating a stratum of material from an adjacent stratum of material comprising:
a first film having a proximal end and a distal end and folded therebetween to form a first barrier having double the film thickness when in an isolating configuration;
a second film having a proximal end and a distal end and folded therebetween to form a second barrier having double the film thickness when in an isolating configuration; and
a pull tab coupled to the proximal ends of the first and second films for pulling the proximal ends of the first film and the second film in a direction generally aligned with the plane of the folded films to unfold and remove the films from their isolating configurations.

6. A removable barrier apparatus for isolating a stratum from an adjacent stratum comprising:
a first film having a proximal end and a distal end, the proximal end coupled to a distal end of a tether;
a second film having a proximal end and a distal end, the proximal end coupled to a distal end of the tether;
the tether having a first side, a second side, and a proximal end opposite the distal end;
the first film adapted for being positionable adjacent to and against the tether and the second film adapted for being positionable adjacent to and against the opposite side of the tether to form a removable barrier of at least two film layers in thickness.

7. The removable barrier apparatus of claim 6 wherein the tether is a third film that is intermediate the first and second films.

8. An enclosure for marking a surface with ink or dye having a plurality of generally adjacent compartments separated by one or more intermediate walls comprising:
a first removable barrier disposed in contact with an intermediate wall of the enclosure to close one or more apertures in the intermediate wall; and
a second removable barrier disposed in contact with an exterior wall of the enclosure to close one or more apertures in the exterior wall;
wherein removal of the first removable barrier places compartments on either side of the intermediate wall in communication; and
wherein removal of the second removable barrier enables transfer of a dye or ink from a compartment to a surface.

9. The enclosure of claim 8 wherein one compartment of the enclosure is adapted for receiving an ink or dye and the adjacent compartment opposite the intermediate wall is adapted for receiving a stencil.

10. The enclosure of claim 8 wherein the removable barrier disposed on the intermediate wall is coupled to a tether and the removable barrier disposed on the exterior wall is coupled to a tether, the tethers adapted for peeling the removable barriers at least partially from their contact with the intermediate wall and exterior wall.

11. The enclosure of claim 8 wherein at least one of the compartments is sealable.

12. The enclosure of claim 8 further comprising an ink pad.

13. The enclosure of claim 8 further comprising at least one of a transfer or stencil.

14. The removable barrier apparatus of claim 4 further comprising:
an enclosure having a resealable closure at a first end for receiving strata of material and an elongated slit at the other end for sealably receiving the tether.

15. The removable barrier apparatus of claim 5 further comprising:
an enclosure having a resealable closure at a first end for receiving strata of material and an elongated slit at the other end for sealably receiving the pull tab.

16. The removable barrier apparatus of claim 6 further comprising:
an enclosure having a resealable closure at a first end for receiving strata of material and an elongated slit at the other end for sealably receiving the tether.
